(19) United States
(12) Patent Application Publication
(10) Pub. No.: US 2012/0127916 A1
(43) Pub. Date: May 24, 2012

(54) WIRELESS COMMUNICATION METHOD AND SYSTEM

(75) Inventors: Sangkeun YOO, Yeongi-gun (KR); Taekon Kim, Seongnam-si (KR); Yong-Woon Kim, Cheonan-si (KR); Hyoung Jun Kim, Daejeon (KR)

(73) Assignee: Electronics and Telecommunications Research Institute, Daejeon (KR)

(21) Appl. No.: 13/295,810

(22) Filed: Nov. 14, 2011

(30) Foreign Application Priority Data
Nov. 19, 2010 (KR) 10-2010-0115860

(51) Int. Cl. H04B 7/14

(52) U.S. Cl. 370/315

(57) ABSTRACT

A wireless communication system includes a plurality of nodes and a base station. The plurality of nodes include a connection node that is positioned at a BS range of the base station to transmit and receive a packet to and from the base station, or that is positioned outside a BS range of the base station to transmit and receive a packet to and from the base station through other connection nodes, and a relay request node that is positioned at a periphery of the connection node and that transmits a relay request to the connection node when the relay request node deviated from a BS range of the base station.

### CROSS-REFERENCE TO RELATED APPLICATION

This application claims priority to and the benefit of Korean Patent Application No. 10-2010-0115860 filed in the Korean Intellectual Property Office on Nov. 19, 2010, the entire contents of which are incorporated herein by reference.

### BACKGROUND OF THE INVENTION

(a) Field of the Invention

The present invention relates to a wireless communication method and system.

(b) Description of the Related Art

Currently, local area wireless communication technologies (wireless local area networks (WLAN), wireless personal area networks (WPAN), and wireless body area networks (WBAN)) together with rapid development of wide area wireless communication technologies (wireless wide area networks (WWAN) and wireless metropolitan area networks (WMAN)) are widely used. Wi-Fi, which is the most widely using technology of wireless LAN technologies provides a local area wireless communication service at many locations including schools, offices, and public institutions all over the world. In addition, Bluetooth and ZigBee, which are wireless PAN technologies, extend the use range, and relatively most recently developed wireless BAN technologies will be spotlighted sooner or later. Such local area wireless communication technologies become a target of concern as a wireless communication technology of various sensor networks that are expected as a future service model in various fields.

Local area wireless communication technology provides a point-to-point communication service that can perform direct communication between nodes in addition to a base station-based communication service. However, the point-to-point communication service is very limitedly used in a reliability viewpoint of communication. Further, in a sensor network environment, base-station-based communication plays an important role. Further, in wireless wide area communication using base-station-based communication, connectivity of a communication service according to movement of a node is guaranteed, whereas local area wireless communication technology does not generally guarantee such connectivity. Guarantee of connectivity according to movement of a node remarkably improves communication reliability of a local area wireless communication service and can largely extend a possible communication range.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a local area wireless communication method and system having advantages of being capable of performing multihop communication for allowing communication even in a case where a wireless communication device deviates from a communication area by solving a problem of a network connection according to movement of the wireless communication device.

An exemplary embodiment of the present invention provides a wireless communication method. The method includes: transmitting, by a relay request node that deviates from a base station (BS) range of a base station, a relay request to a connection node that is positioned at a periphery of the relay request node, wherein the connection node is positioned in a BS range of the base station to transmit and receive a packet to and from the base station, or is positioned outside a BS range of the base station to transmit and receive a packet to and from the base station through other connection nodes; transmitting, when a response to the relay request is received from the connection node, data to transmit to the base station to the connect node; and receiving data that are transmitted by the base station from the connect node, wherein the connection node transmits a response to the relay request to the relay request node and then relays transmission and reception of a packet of the base station or other connection nodes that connect the connect node to the base station.

Another embodiment of the present invention provides a wireless communication method. The method includes: receiving, by a connection node that is positioned at a periphery of a relay request node that deviates from a BS range of a base station, a relay request from the relay request node and transmitting a response to the relay request to the relay request node; receiving, by the connection node, data from the relay request node; transmitting, if the connection node is positioned in a BS range of the base station, data that are received from the relay request node to the base station; and transmitting, if the connection node is not positioned in a BS range of the base station, the relay request to other connection nodes that are positioned at a periphery of the connection node, receiving a response to the relay request, and then transmitting the received data to the other connection nodes.

Yet another embodiment of the present invention provides a wireless communication system. The wireless communication system includes: a connection node that is positioned in a BS range of a base station to transmit and receive a packet to and from the base station, or that is positioned outside a BS range of a base station to transmit and receive a packet to and from the base station through other connection nodes; and a relay request node that is positioned at a periphery of the connection node and that transmits a relay request to the connection node when the relay request node deviates from a BS range of the base station, wherein the connection node transmits a response to the relay request to the relay request node and then relays transmission and reception of a packet of the base station or connection nodes that connect the connection node to the base station.

### BRIEF DESCRIPTION OF THE DRAWINGS

FIG. 1 is a diagram illustrating a configuration of a wireless communication system according to an exemplary embodiment of the present invention.

FIGS. 2A and 2B are flowcharts illustrating a wireless communication method according to an exemplary embodiment of the present invention.

FIG. 3 is a flowchart illustrating a wireless communication method according to another exemplary embodiment of the present invention.

FIG. 4 is a flowchart illustrating operation of a node according to an exemplary embodiment of the present invention.

FIG. 5 is a flowchart illustrating operation of a node according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. The drawings and description are to be regarded as illustrative in nature and not restrictive. Like reference sequences designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

In this specification, a terminal may indicate a mobile station (MS), a mobile terminal (MT), a subscriber station (SS), a portable subscriber station (PSS), user equipment (UE), and an access terminal (AT) and may include an entire function or a partial function of the MS, the MT, the SS, the PSS, the UE, and the AT.

In this specification, a base station (BS) may indicate an access point (AP), a radio access station (RAS), a node-B, an evolved node-B (eNB), a base transceiver station (BTS), and a mobile multihop relay (MMR)-BS, and may include an entire function or a partial function of the AP, the RAS, the node-B, the eNB, the BTS, and the MMR-BS.

Hereinafter, a wireless communication method and system according to an exemplary embodiment of the present invention will be described with reference to the drawings.

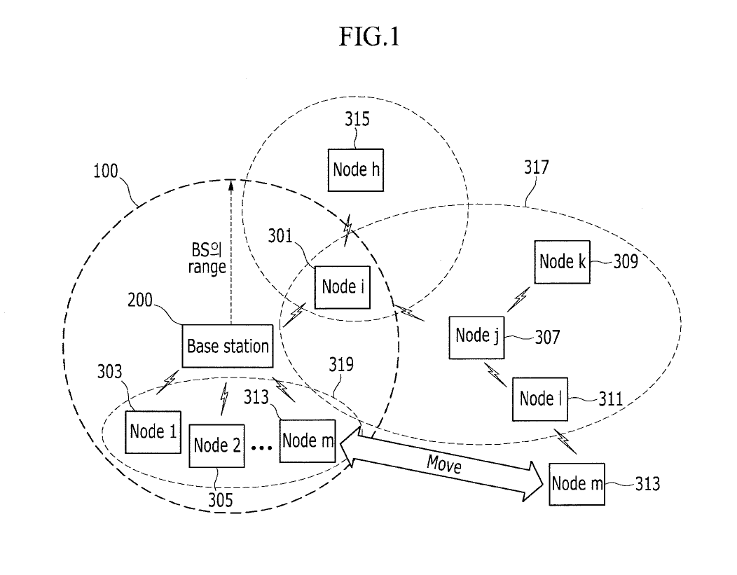

FIG. 1 is a diagram illustrating a configuration of a wireless communication system according to an exemplary embodiment of the present invention.

Referring to FIG. 1, the wireless communication system includes an n-quantity of a plurality of nodes (301-313, n>m) and a BS 200 having a predetermined radius of BS range 100, which is a possible communication range. Such a plurality of nodes 301-313 are mobile nodes, and they perform a function of a terminal device.

Here, the base station 200 can be moved, but is installed at a predetermined specific position and mainly performs a gateway function. The base station 200 transmits a beacon frame, is an upper-level node of a plurality of nodes 301-313 constituting a wireless communication system, and performs a function of a coordinator of a wireless communication system.

Although not separately shown in the drawings, a plurality of nodes 301-313 have a predetermined radius of BS range 317 and 319, respectively. In this case, the BS ranges 317 and 319 of each node are overlapped with the BS range 100.

In this case, as each of a node 1 303, . . . , and node m 313 of the n-quantity of a plurality of nodes 303-313 moves, each node may deviate from the BS range 100.

Accordingly, communication between the node 1 303, . . . , and the node m 313 and the base station 200 is disconnected. In this case, the node 1 301, . . . , and the node m 313 transmit a relay request to an adjacent node.

For example, when the node m 313 is described, the node m 313 transmits a relay request to the node l 311. That is, by grasping a communication transmitting/receiving packet of peripheral nodes, the node m 313 determines that the node l 311 is directly or indirectly connected to the base station 200. Because the node l 311 is connected for communication to the base station 200 through the node j 307, the node l 311 transmits a relay request of the node m 313 to the node j 307 that performs a relay function. Because the node j 307 is connected for communication to the base station 200 through the node i 301, the node j 307 transmits a relay request of the node m 313 to an adjacent node i 301 that performs a relay function.

In this case, because the node i 301 is connected for communication to the base station 200, the node m 313 transmits and receives data to and from the base station 200 through the node i 301, the node j 307, and the node l 311. That is, the node i 301, the node j 307, and the node l 311 operate as a router that relays wireless communication between the base station 200 and the node m 313. That is, the node i 301, the node j 307, and the node l 311 extend a communication region by performing a relay function.

Therefore, the node i 301 that is included in the BS range 100 of the base station 200 is connected with a direct link to the base station 200, but as the node j 307 is positioned outside the BS range 100 of the base station 200, the node j 307 that cannot directly communicate with the base station 200 is connected to the base station 200 through the node i 301. That is, as the node 301 is positioned between the base station 200 and the node j 307, the node i 301 relays data that are transmitted and received between the base station 200 and the node j 307.

Further, the node l 311 to which communication with the base station 200 is disconnected is connected to the base station 200 through the node i 301 and the node j 307. That is, as the node i 301 and the node j 307 are positioned between the base station 200 and the node l 311, the node i 301 and the node j 307 relay data that are transmitted and received between the base station 200 and the node l 311.

Here, a node that is positioned at the BS range 100 of the base station 200 to transmit and receive a packet to and from the base station 200, or a node that is positioned outside the BS range 100 of the base station 200 to transmit and receive a packet to and from the base station 200 through other connection nodes, is referred to as a connection node, and the node i 301, the node j 307, and the node l 311 are examples thereof.

Further, when a node is positioned at the periphery of a connection node and deviates from the BS range 100 of the base station 200, the node that transmits a relay request to the connection node is referred to as a relay request node, and the node m 313 is an example thereof.

The above-described wireless communication system may be a local area wireless communication system that transmits and receives data between the nodes 301-313 or between the base station 200 and the nodes 301-313 using a local area wireless communication protocol.

In this case, according to an exemplary embodiment of the present invention, as a local area wireless communication protocol, a MAC protocol of IEEE 802.15.4 can be used. According to an IEEE 802.15.4 standard, a device type that participates in a wireless communication system includes a full function device (FFD) and a reduced function device (RFD). The FFD has and operates a complete protocol set of a local area wireless communication system. The FFD operates as a lower-level node for the base station 200 and functions as an upper-level node for the RFD. The RFD can be moved, but has no routing function and has no communication function between RFDs. Further, the RFD operates as an end device that loads a simple application mainly using limited resources and only a memory.

In such a local area wireless communication system, when the FFD is connected with a link to the base station 200 and when the FFD or RFD deviates from the BS range 100 of the base station 200, the FFD transmits a relay request to an adjacent FFD and transmits and receives data to and from the base station 200 by relay of the FFD.

Hereinafter, operation of the above-described wireless communication system will be described in each exemplary embodiment.

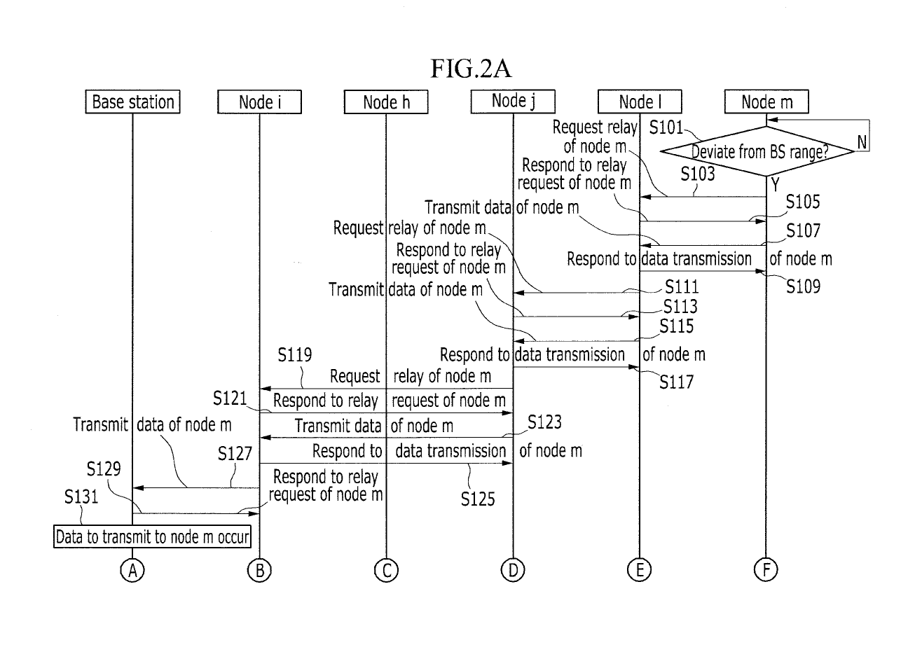

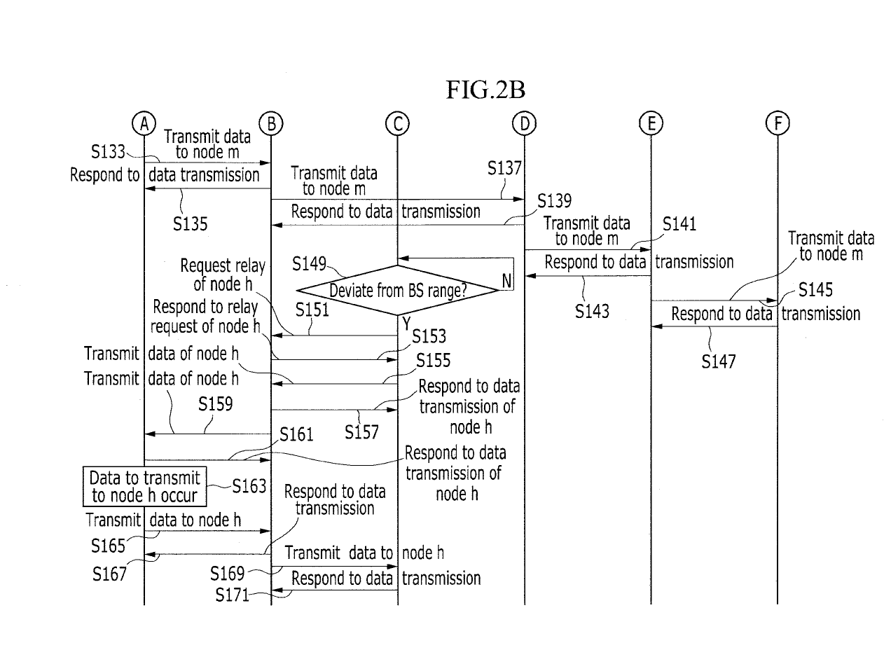

FIGS. 2A and 2B are flowcharts illustrating a wireless communication method according to an exemplary embodiment of the present invention.

Referring to FIG. 2A, it is determined whether the node m 313 deviates from the BS range 100 of the base station 200 (S101). For example, when a beacon frame in which the base station 200 periodically transmits to all nodes within the BS range 100 is not received, it is determined that the node m 313 deviates from the BS range 100.

If the node m 313 deviates from the BS range 100 and communication is thus disconnected, the node m 313 transmits a relay request to an adjacent node, i.e., the node l 311 (S103). When the node m 313 receives a response to the relay request from the node l 311 (S105), the node m 313 transmits data to the node l (S107) and the node m 313 receives a response (ACK) to data transmission from the node l 311 (S109).

Further, the node l 311 transmits a relay request to a connection node, i.e., the node j 307 that allows a relay to the base station 200 (S111). When the node l 311 receives a response to the relay request from the node j 307 (S113), the node l 311 transmits the data that are received at step S107 to the node j 307 (S115) and the node l 311 receives a response to data transmission from the node j 307 (S117).

Further, the node j 307 transmits a relay request to a connection node, i.e., the node i 301 that allows a relay to the base station 200 (S119). When the node j 307 receives a response to the relay request from the node i 301 (S121), the node j 307 transmits the data that are received at step S115 to the node i 301 (S123) and the node j 307 receives a response to data transmission from the node i 301 (S125).

In this case, because the node i 301 is connected to the base station 200, the node i 301 transmits the response to transmission data that are transmitted to the node j 307 to the base station 200 and transmits the data that are received at step S123 to the base station 200 (S127). Thereafter, the base station 200 transmits a response to data transmission representing whether data reception has succeeded to the node i 301 (S129).

Thereafter, when data that the base station 200 is to transmit to the node m 313 occur (S131), referring to FIG. 2B, the base station 200 transmits data to the node i 301 (S133). The node i 301 transmits a response to data transmission to the base station 200 (S135), and the node i 301 transmits the data that are received at step S123 to the node j 307 (S137).

Accordingly, the node j 307 transmits a response to data transmission to the node i 301 (S139), and the node j 307 transmits the data that are received at step S137 to the node l 311 (S141). Thereafter, the node l 311 transmits a response to data transmission to the node j 307 (S143).

The node l 311 transmits the data that are received at step S141 to the node m 313 (S145). The node m 313 transmits a response to data transmission to the node l 311 (S147). In this way, the node i 301, the node j 307, and the node l 311 receive data from the node m 313, transmit the data to the base station 200, and transmit the data that are received from the base station 200 to the node m 313 and thus allow communication between the base station 200 and the node m 313 that deviates from the BS range 100 of the base station 200.

In the foregoing description, the node m 313 was described, but the node i 301, the node j 307, and the node l 311 that deviate from the BS range 100 of the base station 200 can also perform communication with the base station 200 through the node i 301.

Another node, i.e., a random node h 315, will now be described. It is determined whether the node h 315 deviates from the BS range 100 of the base station 200 (S149).

If the node h 315 deviates from the BS range 100 and communication is thus disconnected, the node h 315 transmits a relay request to an adjacent node, i.e., the node i 301 (S151). When the node h 315 receives a relay response from the node i 301 (S153), the node h 315 transmits data to the node i 301 (S155), and the node h 315 receives a response (ACK) to data transmission from the node i 301 (S157).

Because the node i 301 is connected to the base station 200, the node i 301 transmits a response to transmission data that are transmitted to the node h 315 to the base station 200 and transmits the data that are received at step S155 to the base station 200 (S159). Thereafter, the base station 200 transmits a response to data transmission representing whether data reception has succeeded to the node i 301 (S161).

Thereafter, when data that the base station 200 is to transmit to the node h 315 occur (S163), the base station 200 transmits data to the node i 301 (S165). After the node i 301 transmits a response to data transmission to the base station 200 (S167), the node i 301 transmits the data that are received at step S165 to the node h 315 (S169). Thereafter, the node h 315 transmits a response to data transmission to the node i 301 (S171).

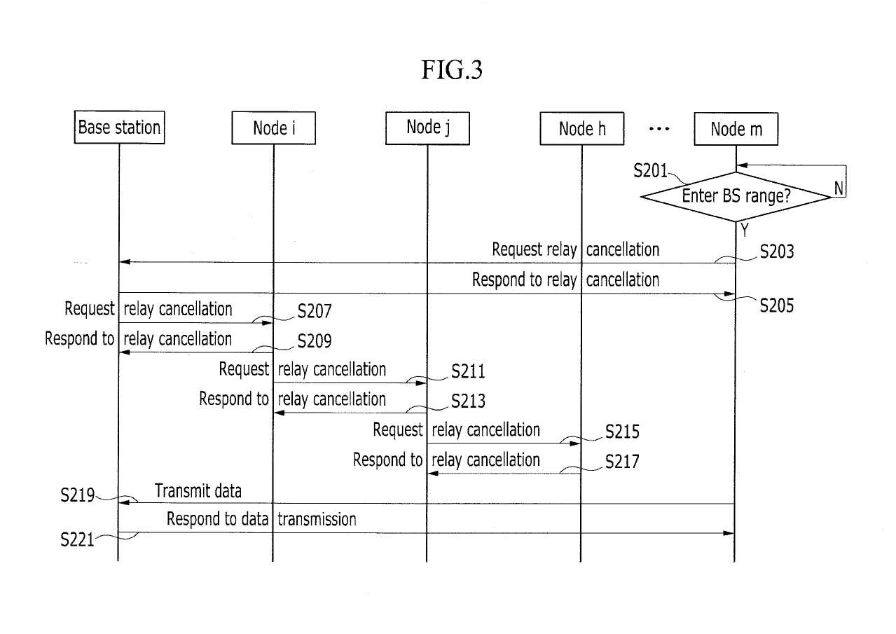

FIG. 3 is a flowchart illustrating a wireless communication method according to another exemplary embodiment of the present invention, and illustrates operation of a case of reentering the BS range 100 of the base station 200.

Referring to FIG. 3, after the node m 313 deviates from the BS range 100 of the base station 200, it is determined whether the node m 313 reenters the BS range 100 of the base station 200 (S201), and if the node m 313 reenters the BS range 100 of the base station 200, the node m 313 requests relay cancellation to the base station 200 (S203). The base station 200 transmits a response to the relay cancellation to the node m 313 (S205).

The base station 200 requests relay cancellation to the node i 301 (S207) and the base station 200 receives a response to the relay cancellation from the node i 301 (S209). Thereafter, the node i 301 requests relay cancellation to the node j 307, which is an adjacent node (S211), and the node i 301 receives a response to the relay cancellation from the node j 307 (S213). Thereafter, the node j 307 requests relay cancellation to the node h 315 (S215) and the node j 307 receives a response to the relay cancellation from the node h 315 (S217).

Thereafter, the node m 313 directly transmits data to the base station 200 (S219) and the node m 313 receives a response to data transmission from the base station 200 (S221).

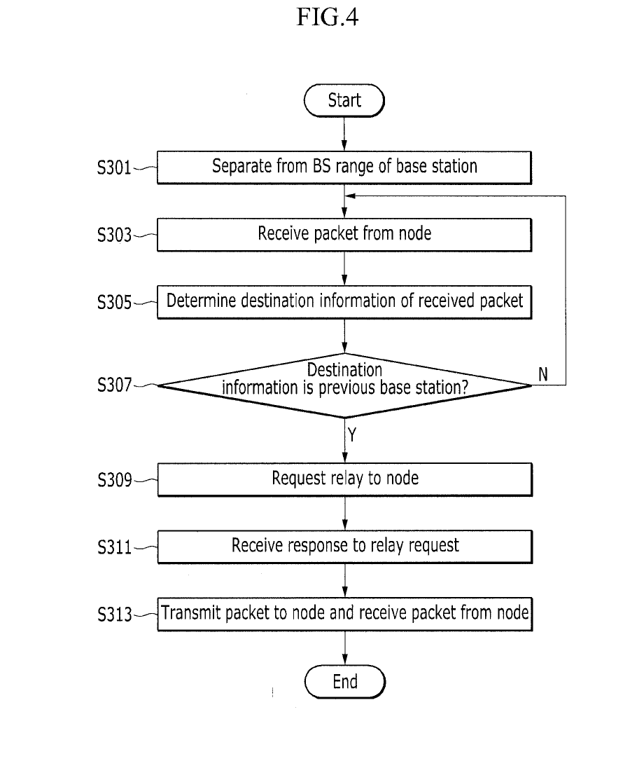

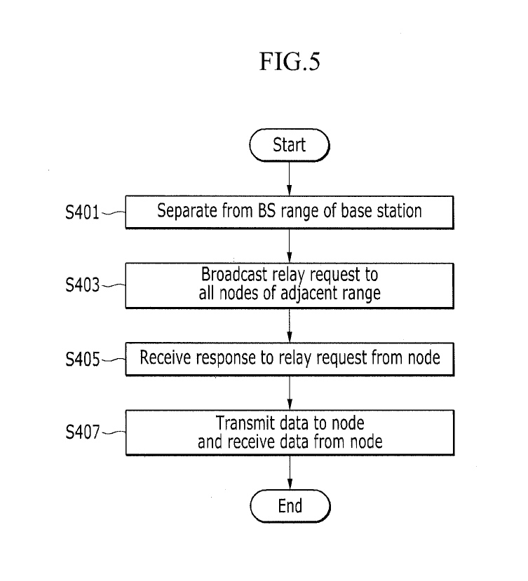

FIGS. 4 and 5 are flowcharts illustrating operation of a node that deviates from the BS range 100 of the base station 200 in each exemplary embodiment.

FIG. 4 is a flowchart illustrating operation of a node according to an exemplary embodiment of the present invention.

Referring to FIG. 4, as a random node moves, the random node separates from the BS range 100 of the base station 200 (S301). In this case, the random node receives a packet from an adjacent node (S303).

Thereafter, the random node determines destination information of the packet that is received at step S303 (S305). Here, it is determined whether destination information of the packet is the previous base station 200 to which the random node has been connected for service (S307).

If destination information of the packet is the previous base station 200 to which the random node has been connected for service, the random node transmits a relay request to an adjacent node that transmits a packet at step S303 (S309).

When the random node receives a response to the relay request from the adjacent node (S311), the random node transmits a packet to the adjacent node (S313). Accordingly, the adjacent node transmits the packet to the base station 200. The random node receives the packet that is transmitted by the base station 200 through the adjacent node (S313).

FIG. 5 is a flowchart illustrating operation of a node according to another exemplary embodiment of the present invention.

Referring to FIG. 5, when a random node separates from the BS range 100 of the base station 200 (S401), the random node broadcasts a relay request to all nodes of an adjacent range (S403).

In this case, when the adjacent node receives a response to the relay request from the random node (S405), the adjacent node transmits data to transmit to the base station 200 to the random node, having transmitted the relay response (S407). The adjacent node receives data that are transmitted by the base station 200 through the random node (S407).

A relay request and a response to the relay request are a form of a new message that has been previously communicated by the base station 200 and a plurality of nodes. A local area wireless communication protocol specification between the base station 200 and a plurality of nodes can apply in a specification of a new message.

For example, a MAC protocol standard specification of IEEE 802.15.4 can be applied in a specification of such a new message.

According to an exemplary embodiment of the present invention, by relaying data transmission and reception between a node that is far separated from a base station and the base station, a BS range can be extended. In this case, compatibility with a conventional local area wireless communication protocol is completely sustained and a relay function is performed by adding a minimum control packet.

Therefore, mobility, which is an essential function for a wireless sensor network that conventional local area wireless communication technologies do not have, is guaranteed. While using a frequency band that an existing network uses, a wireless communication area similar to a wireless mesh function can be remarkably extended. Finally, use of local area wireless communication technologies in a wireless sensor network environment can be innovatively enhanced.

An exemplary embodiment of the present invention may not only be embodied through the above-described apparatus and/or method, but may also embodied through a program that executes a function corresponding to a configuration of an exemplary embodiment of the present invention and through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless communication method comprising:
transmitting, by a relay request node that deviates from a base station (BS) range of a base station, a relay request to a connection node that is positioned at a periphery of the relay request node, wherein the connection node is positioned in a BS range of the base station to transmit and receive a packet to and from the base station, or is positioned outside a BS range of the base station to transmit and receive a packet to and from the base station through other connection nodes;
transmitting, when a response to the relay request is received from the connection node, data to transmit to the base station to the connect node; and
receiving data that are transmitted by the base station from the connect node,
wherein the connection node transmits a response to the relay request to the relay request node and then relays transmission and reception of a packet of the base station or other connection nodes that connect the connect node to the base station.

2. The wireless communication method of claim 1, wherein the transmitting of a relay request comprises:
detecting, if the relay request node deviates from a BS range of the base station, a packet in which the connection node transmits and receives;
determining whether a destination of the detected packet is the base station; and
transmitting, if the destination of the detected packet is the base station, the relay request to the connect node.

3. The wireless communication method of claim 1, wherein the transmitting of a relay request comprises:
broadcasting, if the relay request node deviates from a BS range of the base station, the relay request to all connection nodes of an adjacent region; and
determining whether a response to broadcasting of the relay request is received,
wherein the transmitting of data to transmit to the base station to the connect node comprises transmitting, if a response to broadcasting of the relay request is received, data to transmit to the base station to the connection node, having transmitted the response.

4. The wireless communication method of claim 1, further comprising:
after the receiving of data that are transmitted by the base station from the connect node,
requesting, if the relay request node directly receives a packet from the base station and reenters a BS range of the base station, a relay cancellation to the base station; and
directly transmitting and receiving the packet to and from the base station.

5. A wireless communication method comprising:
receiving, by a connection node that is positioned at a periphery of a relay request node that deviates from a BS range of a base station, a relay request from the relay request node and transmitting a response to the relay request to the relay request node;
receiving, by the connection node, data from the relay request node;
transmitting, if the connection node is positioned at a BS range of the base station, data that are received from the relay request node to the base station; and
transmitting, if the connection node is not positioned at a BS range of the base station, the relay request to other connection nodes that are positioned at a periphery of the connection node, receiving a response to the relay request, and then transmitting the received data to the other connection nodes.

6. The wireless communication method of claim 5, wherein if the other connection node is not positioned in a BS range of the base station, the other connection node performs transmission of the relay request to another connection node that is positioned at a periphery of the other connection node, reception of a relay response, and transmission of the received data.

7. The wireless communication method of claim 5, further comprising,
after the transmitting of the relay request to other connection nodes that are positioned at a periphery of the connection node, receiving a response to the relay request, and then transmitting the received data to the other connection nodes,
transmitting, by the connection node, data that are directly received from the base station or data that are received from the base station through the other connect node to the relay request node.

8. The wireless communication method of claim 5, further comprising,
after the transmitting of the relay request to other connection nodes that are positioned at a periphery of the connection node, receiving a response to the relay request, and then transmitting the received data to the other connection nodes,
requesting, by the connection node, when a relay cancellation is requested from the relay request node, a relay cancellation to the base station or the other connection node.

9. A wireless communication system comprising:
a connection node that is positioned in a BS range of a base station to transmit and receive a packet to and from the base station, or that is positioned outside a BS range of a base station to transmit and receive a packet to and from the base station through other connection nodes; and
a relay request node that is positioned at a periphery of the connection node and that transmits a relay request to the connection node when the relay request node deviates from a BS range of the base station,
wherein the connection node transmits a response to the relay request to the relay request node and then relays transmission and reception of a packet of the base station or connection nodes that connect the connection node to the base station.

10. The wireless communication system of claim 9, wherein if the relay request node deviates from a BS range of the base station, the relay request node detects a packet that is transmitted and received by the connection node and determines whether a destination of the packet is the base station, and if a destination of the packet is the base station, the relay request node transmits the relay request to the connection node.

11. The wireless communication system of claim 9, wherein if the relay request node deviates from a BS range of the base station, the relay request node broadcasts the relay request to all connection nodes of an adjacent region and transmits data to transmit to the base station to a connection node, having transmitted a response to broadcasting of the relay request.

12. The wireless communication system of claim 9, wherein if the relay request node deviates from a BS range of the base station, the relay request node transmits a relay request to the connection node and then directly receives a packet from the base station, and if the relay request node reenters a BS range of the base station, the relay request node requests a relay cancellation to the base station and the base station broadcasts relay cancellation of the relay request node to the connection nodes, and the relay request node directly transmits and receives a packet to and from the base station.
